(19) United States
(12) Patent Application Publication
(10) Pub. No.: US 2026/0133369 A1
(43) Pub. Date: May 14, 2026

(54) MICRO-RING RESONATOR FILTERS

(71) Applicant: GlobalFoundries U.S. Inc., Malta, NY (US)

(72) Inventors: Aneesh Dash, Bangalore (IN); Pratyasha Priyadarshini, Bangalore (IN)

(21) Appl. No.: 18/945,675

(22) Filed: Nov. 13, 2024

(51) Int. Cl. G02B 6/293; G02B 6/12; G02B 6/13

(52) U.S. Cl. CPC G02B 6/2934; G02B 6/13; G02B 6/29353; G02B 6/29355; G02B 2006/12147

(57) ABSTRACT

Structures for a micro-ring resonator filter and methods of forming a structure for a micro-ring resonator filter. The structure comprises a bus-ring coupling section including a first Mach-Zehnder interferometer, and a micro-ring resonator section including a ring resonator coupled to the first Mach-Zehnder interferometer. The ring resonator includes a second Mach-Zehnder interferometer.

### BACKGROUND

The disclosure relates to photonic chips and, more specifically, to structures for a micro-ring resonator filter and methods of forming a structure for a micro-ring resonator filter.

Photonic chips are used in many applications and systems including, but not limited to, data-center communication systems and data computation systems. A photonic chip includes a photonic integrated circuit comprised of photonic components, such as modulators, polarizers, and couplers, that are used to manipulate light received from a light source, such as a laser or an optical fiber.

Wavelength-division multiplexing is a technology that multiplexes multiple data streams onto a single optical link. In a wavelength-division multiplexing scheme, a set of data streams is encoded onto optical carrier signals with a different wavelength of light associated with each data stream. At the transmitter side of the optical link, the optical carrier signals of the individual data streams are combined (i.e., multiplexed) into a single multi-wavelength data stream by a set of wavelength-division-multiplexing filters forming a multiplexer, which has a dedicated input for the data stream of each wavelength and a single output at which the combined data streams exit for further propagation through a single optical link. At the receiver side of the optical link, the optical carrier signals are separated (i.e., demultiplexed) from the multi-wavelength data stream by a set of wavelength-division-multiplexing filters forming a demultiplexer, and the separated optical carrier signals of the individual data streams may then be routed to corresponding photodetectors.

Micro-ring resonator filters are used in dense wavelength-division multiplexing for data-center communication applications and telecommunication applications, as well as other applications such as optical switching, optical sensing, and computing. Conventional micro-ring resonator filters are not fully configurable to permit tuning for tailoring to a particular application.

Improved structures for a micro-ring resonator filter and methods of forming a structure for a micro-ring resonator filter are needed.

### SUMMARY

In an embodiment of the invention, a structure for a micro-ring resonator filter is provided. The structure comprises a bus-ring coupling section including a first Mach-Zehnder interferometer, and a micro-ring resonator section including a ring resonator coupled to the first Mach-Zehnder interferometer. The ring resonator includes a second Mach-Zehnder interferometer.

In an embodiment of the invention, a method forming a structure for a micro-ring resonator filter is provided. The method comprises forming a bus-ring coupling section including a first Mach-Zehnder interferometer and forming a micro-ring resonator section including a ring resonator coupled to the first Mach-Zehnder interferometer. The ring resonator includes a second Mach-Zehnder interferometer.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a diagrammatic view of a structure of a micro-ring resonator filter in accordance with embodiments of the invention.

FIG. 2 is a diagrammatic view of a structure for a micro-ring resonator filter in accordance with alternative embodiments of the invention.

FIG. 3 is a diagrammatic view of a structure for a micro-ring resonator filter in accordance with alternative embodiments of the invention.

FIG. 4 is a diagrammatic view of a structure for a micro-ring resonator filter in accordance with alternative embodiments of the invention.

FIG. 5 is a diagrammatic view of a structure for a micro-ring resonator filter in accordance with alternative embodiments of the invention.

FIG. 6 is a diagrammatic view of a structure for a micro-ring resonator filter in accordance with alternative embodiments of the invention.

FIG. 7 is a diagrammatic view of a structure for a ring-assisted-Mach-Zehnder-interferometer circuit in accordance with alternative embodiments of the invention.

FIG. 8 is a diagrammatic view of a structure for a ring-assisted-Mach-Zehnder-interferometer circuit in accordance with alternative embodiments of the invention.

### DETAILED DESCRIPTION

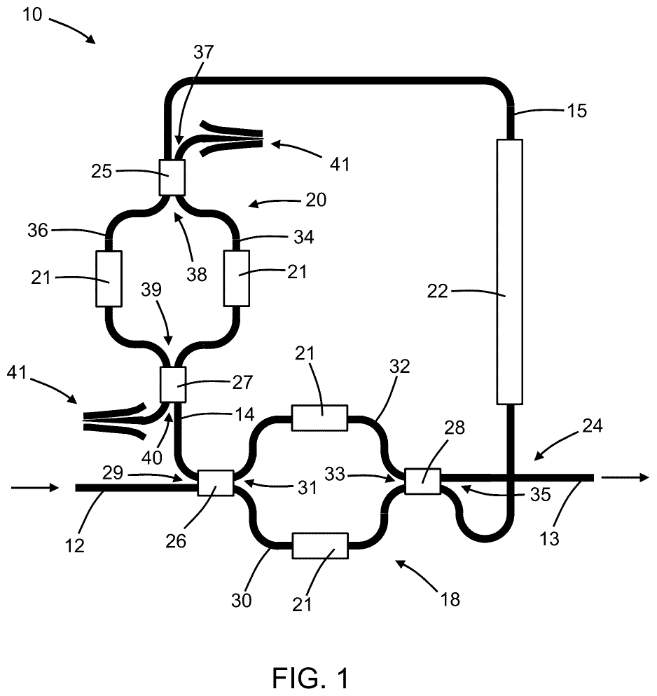

With reference to FIG. 1 and in accordance with embodiments of the invention, a structure 10 for a micro-ring resonator filter includes a waveguide core 12, a waveguide core 13, a waveguide core 14, a waveguide core 15, a Mach-Zehnder interferometer 18, a Mach-Zehnder interferometer 20, a phase shifter 22, and a waveguide crossing 24. The waveguide core 12 provides an input port for providing light to the micro-ring resonator filter and the waveguide core 13 provides a through port for outputting filtered light from the micro-ring resonator filter. The phase shifter 22 is associated with a section of the waveguide core 15 that is arranged between the waveguide crossing 24 and the Mach-Zehnder interferometer 20.

The Mach-Zehnder interferometer 18 includes an arm 30, an arm 32, an optical coupler 26, and an optical coupler 28. The optical coupler 26 has a pair of ports, generally indicated by reference numeral 29, that are respectively coupled to the waveguide core 12 and the waveguide core 14. In an embodiment, the ports 29 may be input ports of the optical coupler 26 that receive light from the waveguide cores 12, 14. The arms 30, 32, which are embodied by waveguide cores similar to the waveguide cores 12, 13, 14, 15, are coupled to respective ports, generally indicated by reference numeral 31, of the optical coupler 26 and are also coupled to respective ports, generally indicated by reference numeral 33, of the optical coupler 28. In an embodiment, the ports 31 may be output ports of the optical coupler 26 that output light to the arms 30, 32, and the ports 33 may be input ports of the optical coupler 28 that receive light from the arms 30, 32. A phase shifter 21 is coupled to each of the arms 30, 32 of the Mach-Zehnder interferometer 18 and the phase shifters 21 may be used to individually adjust the phase of light propagating in the arms 30, 32. The optical coupler 28 has a pair of ports, generally indicated by reference numeral 35, that are respectively coupled to the waveguide core 13 and the waveguide core 15. In an embodiment, the ports 35 of the optical coupler 28 may be output ports that respectively output light to the waveguide core 13 and the waveguide core 15.

The Mach-Zehnder interferometer 20 includes an arm 34, an arm 36, an optical coupler 25, and an optical coupler 27. The optical coupler 25 has a pair of ports, generally indicated by reference numeral 37, that are respectively coupled to the waveguide core 15 and a terminator 41. In an embodiment, the port 37 coupled to the waveguide core 15 may be an input port that receives light from the waveguide core 15. The arms 34, 36, which are embodied by waveguide cores similar to the waveguide cores 12, 13, 14, 15, are coupled to respective ports, generally indicated by reference numeral 38, of the optical coupler 25 and are also coupled to respective ports, generally indicated by reference numeral 39, of the optical coupler 27. In an embodiment, the ports 38 may be output ports of the optical coupler 25 that output light to the arms 34, 36, and the ports 39 may be input ports of the optical coupler 27 that receive light from the arms 30, 32. A phase shifter 21 is coupled to each of the arms 34, 36 of the Mach-Zehnder interferometer 20 and the phase shifters 21 may be used to individually adjust the phase of light propagating in the arms 34, 36. The optical coupler 27 has a pair of ports, generally indicated by reference numeral 40, that are respectively coupled to the waveguide core 14 and a terminator 41. In an embodiment, the port 40 coupled to the waveguide core 14 may be an output port that outputs light to the waveguide core 14. The waveguide core 14 couples the port 40 to one of the ports 29 of the optical coupler 26 such that the light output from the port 40 of the optical coupler 27 is provided to the optical coupler 26.

In an embodiment, the optical couplers 25, 26, 27, 28 may be multimode interference couplers. In alternative embodiments, the optical couplers 25, 26, 27, 28 may be a different type of optical coupler, such as a directional coupler, a Y-junction coupler, or a trident coupler, that is configured to split or combine optical power. In embodiments, the phase shifters 21 and the phase shifter 22 may be electro-optic phase shifters, thermo-optic phase shifters, nonlinear-optical phase shifters, or optomechanical phase shifters. In an embodiment, the optical coupler 25 and the optical coupler 26 may be nominal 50 -50 optical power splitters, and the optical coupler 27 and the optical coupler 28 may be nominal 50 -50 optical power combiners. In alternative embodiments, the Mach-Zehnder interferometers 18, 20 may include more than a pair of arms. The terminators 41 may include an absorber or, alternatively, an absorber may be omitted.

In an embodiment, the waveguide cores 12, 13, 14, 15, the arms 30, 32 of the Mach-Zehnder interferometer 18, the arms 34, 36 of the Mach-Zehnder interferometer 20, and the optical couplers 25, 26, 27, 28 may be comprised of a material having a refractive index that is greater than the refractive index of silicon dioxide. In an embodiment, the waveguide cores 12, 13, 14, 15, the arms 30, 32 of the Mach-Zehnder interferometer 18, the arms 34, 36 of the Mach-Zehnder interferometer 20, and the optical couplers 25, 26, 27, 28 may be comprised of a semiconductor material, such as silicon. In an alternative embodiment, the waveguide cores 12, 13, 14, 15, the arms 30, 32 of the Mach-Zehnder interferometer 18, the arms 34, 36 of the Mach-Zehnder interferometer 20, and the optical couplers 25, 26, 27, 28 may be comprised of a dielectric material, such as silicon nitride, silicon oxynitride, or aluminum nitride. In an alternative embodiment, the waveguide cores 12, 13, 14, 15, the arms 30, 32 of the Mach-Zehnder interferometer 18, the arms 34, 36 of the Mach-Zehnder interferometer 20, and the optical couplers 25, 26, 27, 28 may be comprised of a semiconductor material, such as single-crystal silicon, amorphous silicon, or polycrystalline silicon. In alternative embodiments, other materials, such as a polymer, thin film lithium niobate, barium titanate or a III-V compound semiconductor, may be used to form the waveguide cores 12, 13, 14, 15, the arms 30, 32 of the Mach-Zehnder interferometer 18, the arms 34, 36 of the Mach-Zehnder interferometer 20, and the optical couplers 25, 26, 27, 28. The waveguide cores 12, 13, 14, 15, the arms 30, 32 of the Mach-Zehnder interferometer 18, the arms 34, 36 of the Mach-Zehnder interferometer 20, and the optical couplers 25, 26, 27, 28 may be formed by patterning a layer of the constituent material with lithography and etching processes.

The structure 10 is fully reconfigurable and programmable to permit tuning for tailoring the micro-ring resonator filter to a particular application. The Mach-Zehnder interferometer 20 and the phase shifter 22 are disposed in a micro-ring resonator section of the micro-ring resonator filter embodied in the structure 10. Light may circulate in the waveguide core 15 from the Mach-Zehnder interferometer 18 to the Mach-Zehnder interferometer 20. Light circulating in the micro-ring resonator section may be wavelength filtered in the micro-ring resonator section. The Mach-Zehnder interferometer 20 may be used to tune the internal loss of the micro-ring resonator, which can change the quality factor and/or the extinction ratio of the micro-ring resonator filter. The Mach-Zehnder interferometer 18 is disposed in a bus-ring coupling section of the micro-ring resonator filter embodied in the structure 10. The structure includes an input port represented by the waveguide core 12 for providing light to the bus-ring coupling section and a through port represented by the waveguide core 13 from which filtered light may exit from the bus-ring coupling section. The Mach-Zehnder interferometer 18 may be used to tune the optical power coupled into the micro-ring resonator section, which can also change the quality factor and/or the extinction ratio of the micro-ring resonator filter. The phase shifters 21 and/or the delay lengths of the Mach-Zehnder interferometers 18, 20 may be used to change the quality factor at a fixed extinction ratio or to change the extinction ratio at a fixed quality factor.

In alternative embodiment, multiple micro-ring resonator sections of any of the embodiments of the structure 10 disclosed herein may be coupled together to provide a higher-order micro-ring resonator filter.

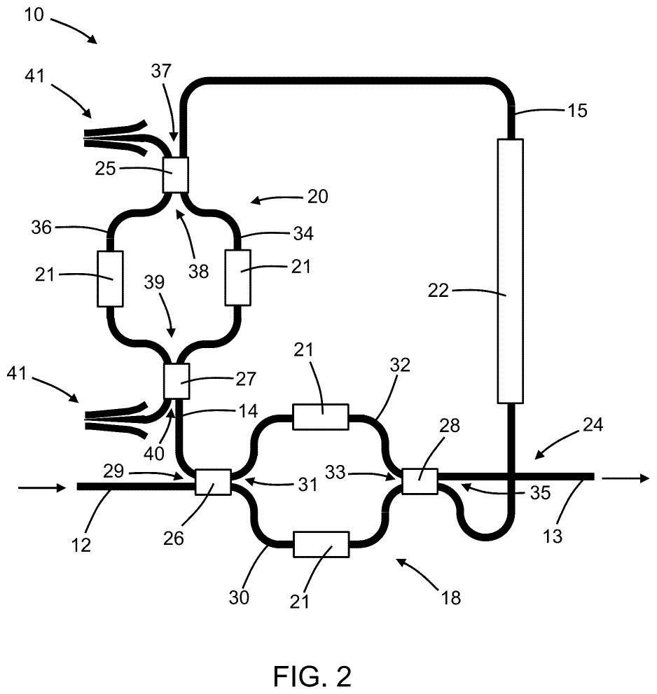

With reference to FIG. 2 and in accordance with alternative embodiments, the terminator 41 may be coupled to a different port 37 of the optical coupler 25 belonging to the Mach-Zehnder interferometer 20.

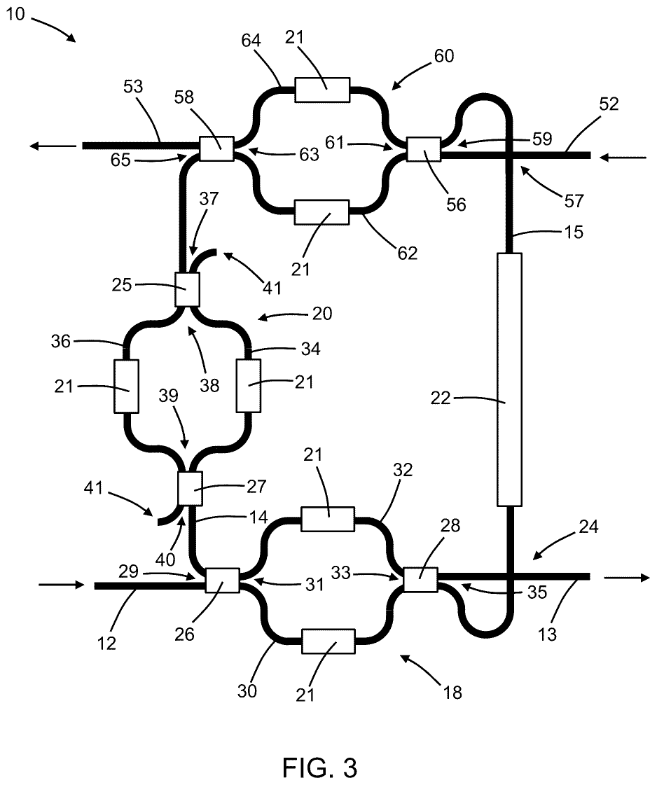

With reference to FIG. 3 and in accordance with alternative embodiments, waveguide cores 52, 53, a waveguide crossing 57, a Mach-Zehnder interferometer 60 may be added to the structure 10 to provide the micro-ring resonator section of the micro-ring resonator filter with a drop port. The Mach-Zehnder interferometer 60 includes an arm 62, an arm 64, an optical coupler 56, and an optical coupler 58. The optical coupler 56 has a pair of ports, generally indicated by reference numeral 59, that are respectively coupled to the waveguide core 15 and the waveguide core 52. In an embodiment, the ports 59 of the optical coupler 56 may be input ports. The arms 62, 64, which are embodied by waveguide cores similar to the waveguide cores 12, 13, 14, 15, are coupled to respective ports, generally indicated by reference numeral 61, of the optical coupler 56 and are also coupled to respective ports, generally indicated by reference numeral 63, of the optical coupler 58. In an embodiment, the ports 61 may be output ports of the optical coupler 56 that output light to the arms 62, 64, and the ports 63 may be input ports of the optical coupler 58 that receive light from the arms 62, 64. A phase shifter 21 is coupled to each of the arms 62, 64 of the Mach-Zehnder interferometer 60 and the phase shifters 21 may be used to individually adjust the phase of light propagating in the arms 62, 64. The optical coupler 58 has a pair of ports, generally indicated by reference numeral 65, that are respectively coupled to the waveguide core 53 and to one of the ports 37 of the optical coupler 25 belonging to the Mach-Zehnder interferometer 60. In an embodiment, the ports 65 may be output ports of the optical coupler 58 that respectively output light to the waveguide core 53 and the port 37 of the optical coupler 25.

Light that is filtered by the micro-ring resonator filter from the light circulating in the micro-ring resonator section may exit the micro-ring resonator filter through the drop port represented by the waveguide core 53. The waveguide core 52 may provide an add port for introducing light to the micro-ring resonator section.

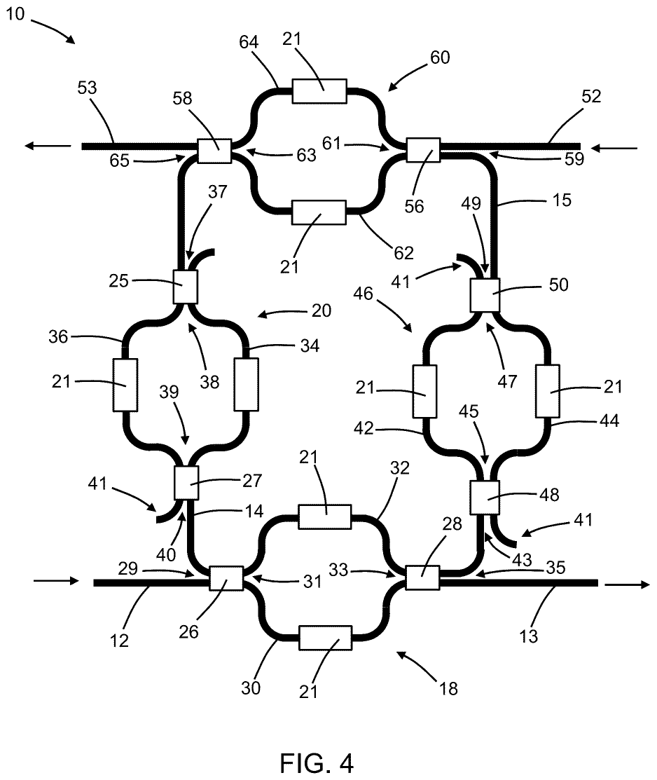

With reference to FIG. 4 and in accordance with alternative embodiments, the phase shifter 22 may be replaced by a Mach-Zehnder interferometer 46 in the micro-ring resonator section of the micro-ring resonator filter embodied in the structure 10. The Mach-Zehnder interferometer 46 includes an arm 42, an arm 44, an optical coupler 48, and an optical coupler 50. The optical coupler 48 has a pair of ports, generally indicated by reference numeral 43, and one of the ports 43 is coupled to one of the ports 35 of the optical coupler 28. In an embodiment, the port 43 coupled to the port 35 of the optical coupler 28 may be an input port of the optical coupler 48. The arms 42, 44, which are embodied by waveguide cores similar to the waveguide cores 12, 13, 14, 15, are coupled to respective ports, generally indicated by reference numeral 45, of the optical coupler 48 and are also coupled to respective ports, generally indicated by reference numeral 47, of the optical coupler 50. In an embodiment, the ports 45 may be output ports that output light from the optical coupler 48 to the arms 42, 44, and the ports 47 may be input ports of the optical coupler 50 that receive light from the arms 42, 44. A phase shifter 21 is coupled to each of the arms 42, 44 of the Mach-Zehnder interferometer 46 and the phase shifters 21 may be used to individually adjust the phase of light propagating in the arms 42, 44. The optical coupler 50 has a pair of ports, generally indicated by reference numeral 49, that are respectively coupled to the waveguide core 15 and to a terminator 41. In an embodiment, the port 49 coupled by the waveguide core 15 to the port 59 of the optical coupler 56 may be an output port of the optical coupler 50 that outputs light to the waveguide core 15.

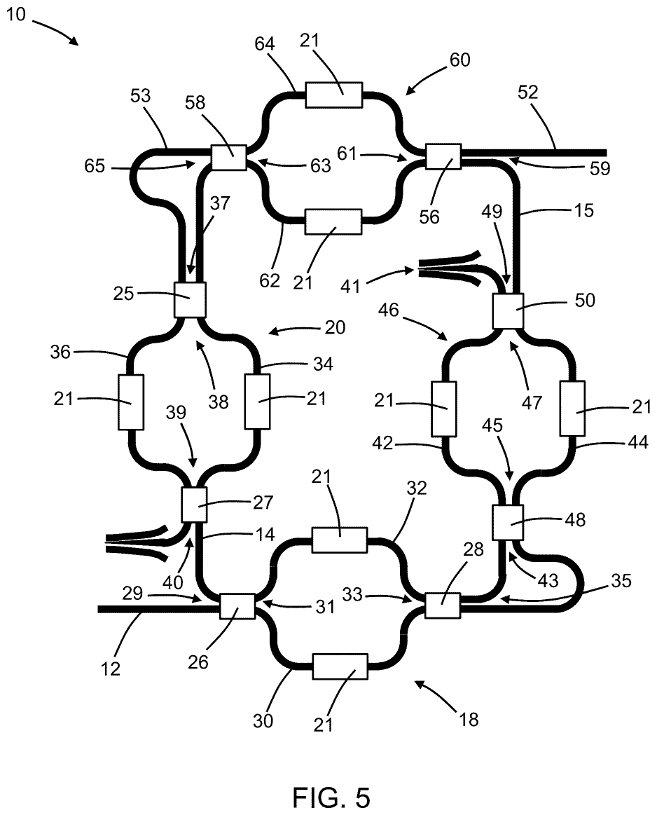

With reference to FIG. 5 and in accordance with alternative embodiments, the Mach-Zehnder interferometer 46 may be configured to route light such that the waveguide core 12 represents an input port to the micro-ring resonator filter and the waveguide core 52 represents an output port from the micro-ring resonator filter. Alternatively, the Mach-Zehnder interferometer 46 may be configured to route light such that the waveguide core 52 represents an input port to the micro-ring resonator filter and the waveguide core 12 represents an output port from the micro-ring resonator filter.

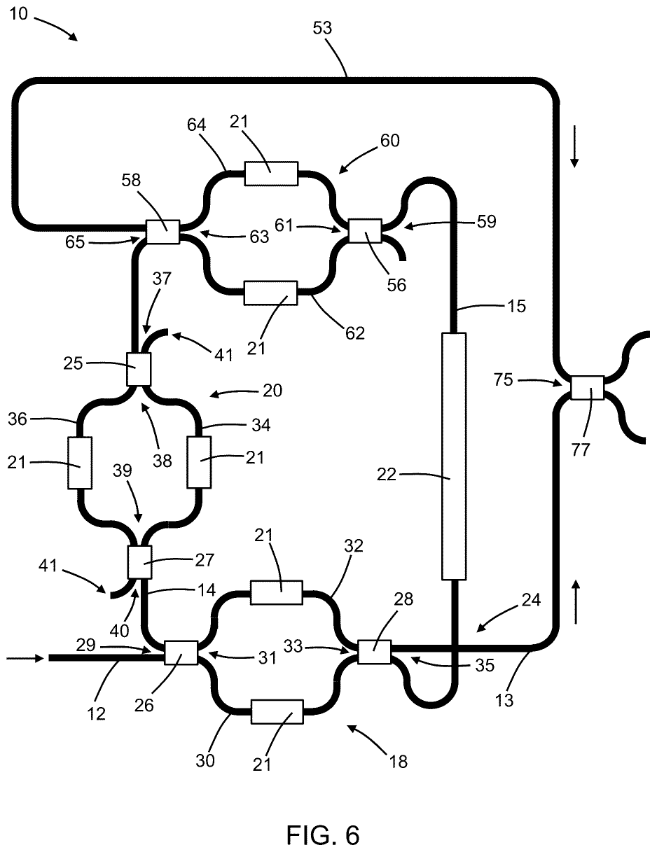

With reference to FIG. 6 and in accordance with alternative embodiments, the micro-ring resonator filter embodied in the structure 10 may include an optical coupler 77 that has a pair of ports 75. In an embodiment, the ports 75 may be input ports of the optical coupler 77. One of the ports 75 of the optical coupler 77 is coupled by the waveguide core 53 to one of the ports 65 of the optical coupler 58, and the other of the ports 75 of the optical coupler 77 is coupled by the waveguide core 13 to one of the ports 35 of the optical coupler 28. The optical coupler 77 also has ports, which may be output ports, coupled to waveguide cores that guide light away from the micro-ring resonator filter.

The micro-ring resonator filter, as embodied in FIG. 6, may function as an interleaver that has the capability of separating and combining light contingent upon the input at the waveguide core 12.

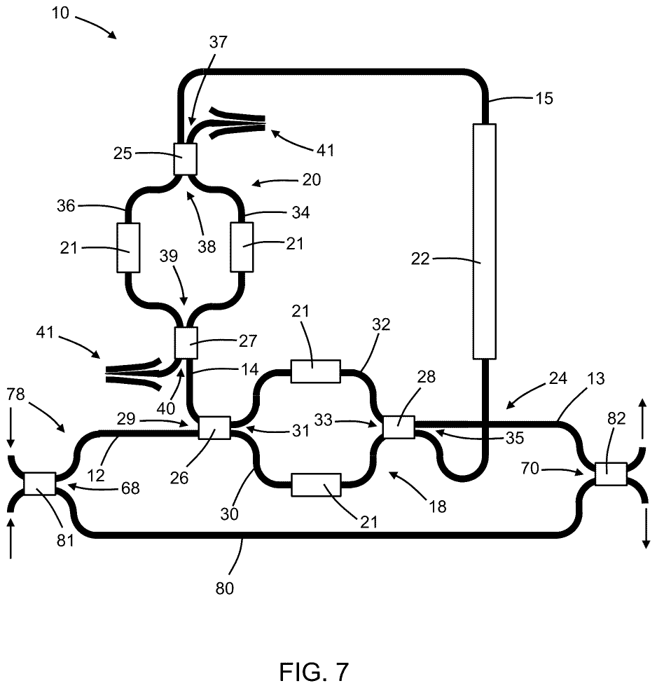

With reference to FIG. 7 and in accordance with alternative embodiments, the structure 10 may be a ring-assisted-Mach-Zehnder-interferometer circuit that includes the micro-ring resonator filter. To that end, the structure 10 may further include a Mach-Zehnder interferometer 78 having the bus-ring coupling section of the of the micro-ring resonator filter as an arm, another arm 80, an optical coupler 81, and an optical coupler 82. Optical power may be split at the optical coupler 81 and combined at the optical coupler 82. The optical coupler 81 has a pair of ports 68, and the optical coupler 82 has a pair of ports 70. In an embodiment, the ports 68 may be output ports of the optical coupler 81, and the ports 70 may be input ports of the optical coupler 82. One of the ports 68 of the optical coupler 81 is coupled by the waveguide core 12 to one of the ports 29 of the optical coupler 26, the other of the ports 68 of the optical coupler 81 is coupled by the arm 80 to one of the ports 70 of the optical coupler 82, and one of the ports 70 of the optical coupler 82 is coupled by the waveguide core 13 to one of the ports 35 of the optical coupler 28.

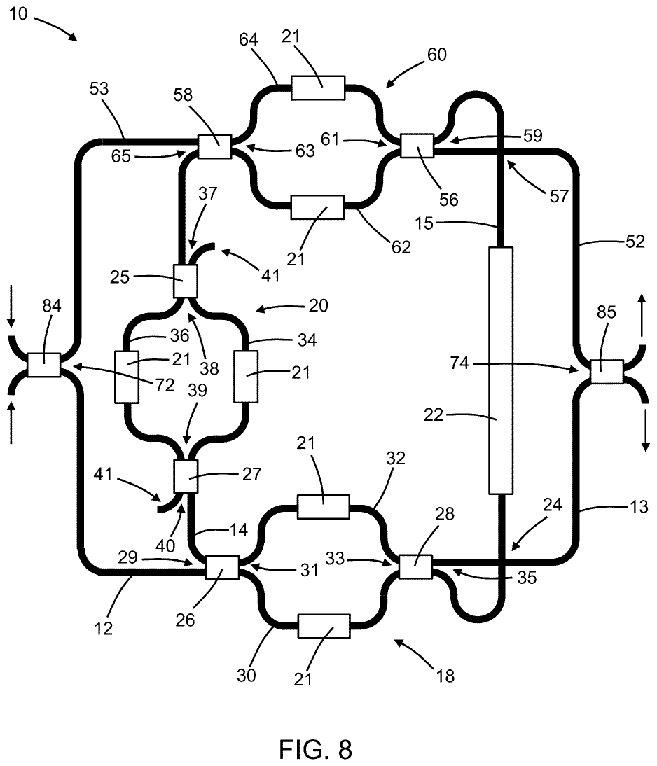

With reference to FIG. 8 and in accordance with alternative embodiments, the structure may include an optical coupler 84 may have a port 72 that is coupled by the waveguide core 53 to a port 65 of the optical coupler 58 and another port 72 that is coupled by the waveguide core 12 to a port 29 of the optical coupler 26. In an embodiment, the ports 72 may be output ports for supplying light to the ring-assisted-Mach-Zehnder-interferometer. The structure 10 may also include an optical coupler 85 may have a port 74 that is coupled by the waveguide core 52 to a port 59 of the optical coupler 56 and another port 74 that is coupled by the waveguide core 13 to a port 35 of the optical coupler 28. In an embodiment, the ports 74 may be input ports for receiving light from the ring-assisted-Mach-Zehnder-interferometer. The optical coupler 84 may also have input ports capable of receiving light from a pair of coupled waveguide cores, and optical coupler 85 may also have output ports capable of providing light to a pair of coupled waveguide cores.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a micro-ring resonator filter, the structure comprising:
a bus-ring coupling section including a first Mach-Zehnder interferometer; and
a micro-ring resonator section including a ring resonator coupled to the first Mach-Zehnder interferometer, the ring resonator including a second Mach-Zehnder interferometer.

2. The structure of claim 1 wherein the first Mach-Zehnder interferometer includes a first optical coupler having a first port and a second port, the second Mach-Zehnder interferometer includes a second optical coupler having a port, and the first port of the first optical coupler is coupled to the port of the second optical coupler.

3. The structure of claim 2 further comprising:
a waveguide core coupled to the second port of the first optical coupler.

4. The structure of claim 3 wherein the waveguide core is configured to provide light to the second port of the first optical coupler.

5. The structure of claim 1 wherein the first Mach-Zehnder interferometer includes a first arm, a second arm, a first phase shifter coupled to the first arm, and a second phase shifter coupled to the second arm.

6. The structure of claim 5 wherein the second Mach-Zehnder interferometer includes a third arm, a fourth arm, a third phase shifter coupled to the third arm, and a fourth phase shifter coupled to the fourth arm.

7. The structure of claim 1 wherein the second Mach-Zehnder interferometer includes a first arm, a second arm, a first phase shifter coupled to the first arm, and a second phase shifter coupled to the second arm.

8. The structure of claim 1 wherein the first Mach-Zehnder interferometer includes a first optical coupler having a first port and a second port, the second Mach-Zehnder interferometer includes a second optical coupler having a first port, and the first port of the first optical coupler is coupled to the first port of the second optical coupler.

9. The structure of claim 8 further comprising:
a waveguide core coupled to the second port of the first optical coupler,
wherein the waveguide core provides the bus-ring coupling section with a through port.

10. The structure of claim 9 wherein the waveguide core is configured to receive filtered light from the second port of the first optical coupler.

11. The structure of claim 8 wherein the ring resonator includes a phase shifter in a guided light path between the first port of the first optical coupler and the first port of the second optical coupler.

12. The structure of claim 11 wherein the ring resonator includes a third Mach-Zehnder interferometer in the guided light path between the phase shifter and the first port of the second optical coupler.

13. The structure of claim 8 wherein the ring resonator includes a third Mach-Zehnder interferometer in a guided light path between the first port of the first optical coupler and the first port of the second optical coupler.

14. The structure of claim 13 wherein the ring resonator includes a fourth Mach-Zehnder interferometer in the guided light path between the first port of the first optical coupler and the first port of the second optical coupler.

15. The structure of claim 13 wherein the third Mach-Zehnder interferometer includes a third optical coupler having a first port and a second port, the first port of the third optical coupler is coupled to the first port of the second optical coupler, and further comprising:
a first waveguide core coupled to the second port of the third optical coupler.

16. The structure of claim 15 wherein the first waveguide core provides the micro-ring resonator section with a drop port.

17. The structure of claim 15 further comprising:
a fourth optical coupler including a first port and a second port; and
a second waveguide core extending from the second port of the first optical coupler to the first port of the fourth optical coupler,
wherein the first waveguide core extends from the second port of the third optical coupler to the second port of the fourth optical coupler.

18. The structure of claim 1 wherein the first Mach-Zehnder interferometer includes a first optical coupler having a first port and a second optical coupler having a second port, and further comprising:
a third optical coupler having a first port and a second port, the first port of the third optical coupler coupled to the first port of the first optical coupler; and
a fourth optical coupler having a first port and a second port, the first port of the fourth optical coupler coupled to the second port of the second optical coupler, and the second port of the fourth optical coupler coupled to the second port of the third optical coupler.

19. The structure of claim 1 wherein the first Mach-Zehnder interferometer includes a first optical coupler having a port, the second Mach-Zehnder interferometer includes a second optical coupler having a port, and further comprising:
a third optical coupler having a first port and a second port, the first port of the third optical coupler coupled to the port of the first optical coupler, and the second port of the third optical coupler coupled to the port of the second optical coupler.

20. A method of forming a structure for a micro-ring resonator filter, the method comprising:
forming a bus-ring coupling section including a first Mach-Zehnder interferometer; and
forming a micro-ring resonator section including a ring resonator coupled to the first Mach-Zehnder interferometer, wherein the ring resonator includes a second Mach-Zehnder interferometer.
